(19) United States
(12) Patent Application Publication
(10) Pub. No.: US 2008/0268293 A1
(43) Pub. Date: Oct. 30, 2008

(54) MAGNETIC RECORDING MEDIUM, METHOD FOR MANUFACTURING THE SAME, AND MAGNETIC RECORDING APPARATUS

(75) Inventor: Antony Ajan, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/060,027

(22) Filed: Mar. 31, 2008

(30) Foreign Application Priority Data
Apr. 27, 2007 (JP) 2007-119401

(51) Int. Cl. G11B 5/66; G11B 5/84

(52) U.S. Cl. 428/831.1; 428/831; 427/131

(57) ABSTRACT

According to an aspect of an embodiment, a magnetic recording medium includes a soft under layer, a seed layer containing an alloy, placed over the soft under layer, a ruthenium containing layer containing crystalline Ru, directly placed on the seed layer, and a recording layer placed over the ruthenium containing layer. The alloy contains metal atoms bonded to one another with a minimum distance of adjacent atoms. The difference between the minimum distance of the atoms in the alloy and that of the atoms in the crystalline Ru is 2% or less.

### BACKGROUND OF THE INVENTION

This art relates to a magnetic recording medium, a method for making the magnetic recording medium, and a magnetic recording apparatus.

Recently, magnetic recording media such as hard disks are widely used as recording media for personal computers, game machines, and the like. Research and development for increasing the density of magnetic recording media including perpendicular magnetic recording media is being pursued.

Examples of arts related to the magnetic recording medium, the method for making the medium and the magnetic recording apparatus are disclosed in Japanese Laid-open Patent Publication Nos. 2004-327006, 2006-155865, 2006-309925, and 2004-348849.

### SUMMARY

According to an aspect of an embodiment, a magnetic recording medium includes a soft under layer, a seed layer containing an alloy, placed over the soft under layer, a ruthenium containing layer containing crystalline Ru, directly placed on the seed layer, and a recording layer placed over the ruthenium containing layer, the alloy containing metal atoms bonded to one another with a minimum distance of adjacent atoms, the difference between the minimum distance of the alloy and that of the crystalline Ru being 2% or less.

### BRIEF DESCRIPTION OF THE DRAWINGS

FIG. 1 is a cross-sectional view showing a structure of a perpendicular magnetic recording medium according to a first embodiment.

FIG. 2 is a diagram showing how the perpendicular magnetic recording medium of the first embodiment is used.

FIG. 3 is a graph showing the relationship between the composition of Ni—Pt and Ni—Pd, the center-to-center distance between nearest neighbor atoms, and the mismatch relative to Ru.

FIG. 4 is a graph showing the results of a first experiment.

FIG. 5 is a graph showing the results of a second experiment.

FIG. 6 is another graph showing the results of the second experiment.

FIG. 7 is a graph showing the results of a third experiment.

FIG. 8 is a graph showing the results of a fourth experiment.

FIG. 9 is a graph showing the results of a fifth experiment.

FIG. 10 is another graph showing the results of a fifth experiment.

FIG. 11 is a graph showing the results of a sixth experiment.

FIG. 12 is a graph showing the results of a seventh experiment.

FIG. 13 is a graph showing the results of an eighth experiment.

FIG. 14 is a graph showing the results of a ninth experiment.

FIG. 15 is a cross-sectional view showing a structure of a perpendicular magnetic recording medium according to a second embodiment.

FIG. 16 is a graph showing the relationship between the Pt ratio in Co—Pt and the lengths of the a-axis and c-axis.

FIG. 17 is a diagram showing the inside structure of a hard disk drive (HDD).

### DESCRIPTION OF THE PREFERRED EMBODIMENTS

A perpendicular magnetic recording medium has a magnetic recording layer and a soft under layer (SUL). A nonmagnetic intermediate layer is provided between the magnetic recording layer and the soft under layer to magnetically isolate the magnetic recording layer from the soft under layer and to thereby reduce noise. A Ru layer is usually provided as the nonmagnetic intermediate layer. In some perpendicular magnetic recording media, a Ta layer, a Pt layer, a Pd layer, a Ti layer, a Ni—Fe layer, a Ni—Fe—Cr layer, a Ni—Cr layer, or the like is disposed between the Ru layer and the soft under layer so as to serve as a seed layer.

In order to improve the recording density of the perpendicular magnetic recording head, it is important that the crystals of the substance constituting the magnetic recording layer be uniformly oriented so that the coercive force is high. For example, when the magnetic recording layer is composed of Co—Pt, it is important that the (0002) miller index faces of the crystals of Co—Pt denoted as Co—Pt (0002) be aligned in the plane of the magnetic recording layer. In order to yield such a state, it is essential to improve the crystallinity of the intermediate layer located immediately under the magnetic recording layer. To achieve the same in the existing perpendicular magnetic recording media, the thickness of the Ru layer is set to 20 nm or more. However, since Ru is an expensive metal, a reduction in the amount of Ru used is desirable to reduce the cost.

On the other hand, it is also important for development of perpendicular magnetic recording media to improve writability. Writability is an index indicating how accurate data can be rewritten. However, at higher recording densities, use of high anisotropic material is inevitable and it will be difficult for existing perpendicular magnetic recording media to achieve satisfactory writability.

Accordingly, it is an object of the present invention to provide a magnetic recording medium that has improved writability while maintaining high coercive force and that contains a smaller amount of Ru, a method for manufacturing such a magnetic recording medium, and a magnetic recording apparatus.

Embodiments will now be described with reference to the attached drawings.

### First Embodiment

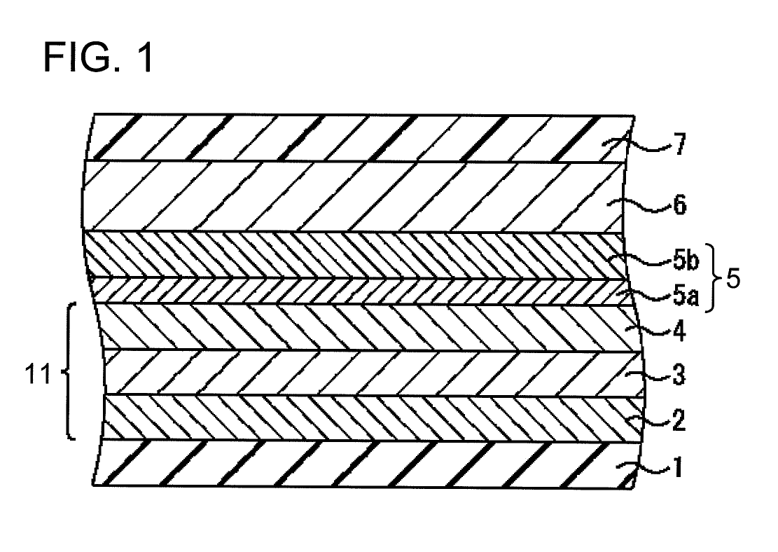

A first embodiment will now be described. FIG. 1 is a cross-sectional view showing the structure of a perpendicular magnetic recording medium according to a first embodiment.

According to the first embodiment, as shown in FIG. 1, an amorphous ferromagnetic layer 2 is disposed on a disk-shaped substrate 1, a spacer layer 3 is disposed on the amorphous ferromagnetic layer 2, and an amorphous ferromagnetic layer 4 is disposed on the spacer layer 3. The amorphous ferromagnetic layer 2, the spacer layer 3, and the amorphous ferromagnetic layer 4 constitute a soft under layer 11.

A plastic substrate, a crystallized glass substrate, a tempered glass substrate, a Si substrate, an aluminum alloy substrate, or the like may be used as the substrate 1.

The amorphous ferromagnetic layers 2 and 4 are ferromagnetic layers (soft magnetic layers) in an amorphous state containing Fe and Co and/or Ni and may further contain Cr, B, Cu, Ti, V, Nb, Zr, Pt, Pd, and/or Ta. Incorporation of one or more of these elements stabilizes the amorphous state and improves the magnetic properties better than when only Fe and Co and/or Ni are incorporated. The amorphous ferromagnetic layers 2 and 4 may further contain Al, Si, Hf, and/or C. Considering the strength of the recording magnetic field, layers composed of a soft magnetic material having a saturation magnetic flux density Bs of 1.0 T or more are preferred. In order to achieve satisfactory writability at a high transmission rate, the high-frequency permeability is preferably high. Examples of such a layer include an FeCoB layer, an FeSi layer, an FeAlSi layer, an FeTaC layer, a CoZrNb layer, a CoCrNb layer, and a NiFeNb layer. The amorphous ferromagnetic layers 2 and 4 may be formed by plating, sputtering, vapor-depositing, or chemical vapor deposition (CVD), for example. When DC sputtering is employed, the atmosphere in the chamber may be Ar at a pressure of 0.5 Pa to 2 Pa, for example. The thickness of the amorphous ferromagnetic layers 2 and 4 is adjusted to 5 nm to 25 nm each, for example.

A nonmagnetic metal layer containing Ru and Cu and/or Cr is formed as the spacer layer 3, for example. The spacer layer 3 may be from one or more of the rare earth metals such as Rh and/or Re. The spacer layer 3 can be formed by plating, sputtering, vapor-depositing, chemical vapor deposition (CVD), or the like. When DC sputtering is employed, the atmosphere of the chamber may be Ar at a pressure of 0.5 Pa to 2 Pa, for example. The thickness of the spacer layer 3 is adjusted so that antiparallel magnetic coupling occurs between the amorphous ferromagnetic layer 2 and the amorphous ferromagnetic layer 4 (e.g., a thickness of 0.3 nm to 3 nm). In other words, the magnetization directions of the amorphous ferromagnetic layers 2 and 4 are opposite to each other, and the amorphous ferromagnetic layers 2 and 4 are antiferromagnetically coupled. Moreover, the relationship Ms₂×t₂=Ms₄×t₄ is established, where Ms₂ is the saturation magnetization and t₂ is the thickness of the amorphous ferromagnetic layer 2 and Ms₄ is the saturation magnetization and t₄ is the thickness of the amorphous ferromagnetic layer 4. Accordingly, the residual magnetization of the soft under layer 11 is zero.

In this embodiment, a seed layer 5a is formed on the soft under layer 11, and a Ru layer 5b is formed on the seed layer 5a. The seed layer 5a and the Ru layer 5b constitute an intermediate layer 5.

The seed layer 5a is composed of an alloy having a face-centered cubic (fcc) crystal structure. In this embodiment, the Miller index of the surface of the seed layer 5a is (111). Moreover, inside the seed layer 5a, the distance between the centers of the adjacent atoms is about 2.70 Å. Examples of such an alloy include Ni—Pt and Ni—Pd. The alloy may further contain SiO₂, TiO₂, Cr, B, Zr, Ta, W, Mn, C and/or Nb, for example. Incorporation of these elements and compounds tends to stabilize the phase of the seed layer 5a, provide finer crystal grains, suppress corrosion, and increase the sputtering rate. However, the amount in which these elements and compounds are added is preferably less than 20 atomic percent. The seed layer 5a may be made by plating, sputtering, vapor-depositing, chemical vapor deposition, or the like. Examples of the alloy constituting the seed layer 5a include Cu—Pd, Cu—Pt, Ni—Au, Cu—Au, and Cu—Al.

Ruthenium has a hexagonal close-packed (hcp) crystal structure, and the “a” parameter is about 2.70 Å. The Miller index of the surface of the Ru layer 5b is (0002) in this embodiment. Accordingly, in this embodiment, the close-packed faces of the crystals constituting the seed layer 5a are parallel to the close-packed faces of Ru constituting the Ru layer 5b, and the distance between the centers of the nearest neighbor atoms or lattice matching is near perfect between the seed layer 5a and the Ru layer 5b. The Ru layer 5b can be formed by plating, sputtering, vapor-depositing, CVD, or any other suitable method. When DC sputtering is employed, the atmosphere in the chamber may be Ar at a pressure of 0.5 Pa to 8 Pa, for example.

A recording layer 6 is formed on the Ru layer 5b. For example, a ferromagnetic layer mainly composed of Co and Pt is formed as the recording layer 6. The recording layer 6 may further contain Cr, B, SiO₂, TiO₂, CrO₂, CrO, Cu, Ti, CoO, Mn, W and/or Nb. For example, a layer in which Co—Cr—Pt crystal grains are isolated from one another by SiO₂ may be used. The recording layer 6 may have a multilayer structure. The recording layer 6 can be formed by, for example, plating, sputtering, vapor-depositing, or CVD. When DC/RF sputtering is employed, the atmosphere in the chamber may be Ar at 0.5 Pa to 6 Pa. In such a case, gas, 0.5% to 10% of which is oxygen, may be used. The thickness of the recording layer 6 is, for example, 8 nm to 20 nm.

A protective layer 7 is disposed on the recording layer 6. For example, an amorphous carbon layer, a hydrogenated carbon layer, a carbon nitride layer, or an aluminum oxide layer is provided as the protective layer 7. The protective layer 7 can be formed by plating, sputtering, vapor-depositing, CVD, or any other suitable method. When DC sputtering is employed, the atmosphere in the chamber may be Ar at 0.5 Pa to 4 Pa. The thickness of the protective layer 7 is, for example, 1 nm to 5 nm.

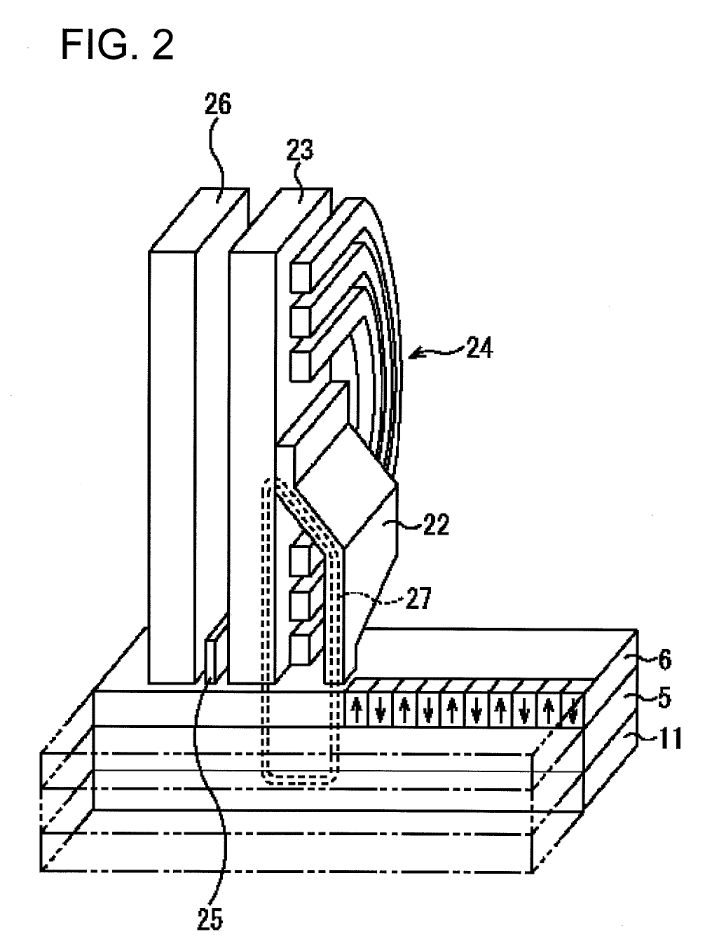

Data is written (recorded) on and read (reproduced) from the perpendicular magnetic recording medium having the above-described structure by using a magnetic head such as the one shown in FIG. 2. A magnetic head 21 for the perpendicular magnetic recording medium includes a main magnetic pole 22 for writing, an auxiliary magnetic pole 23, and a coil 24. The magnetic head 21 also includes a magnetoresistive element 25 for reading and a shield 26. The auxiliary magnetic pole 23 also functions as a shield for the magnetoresistive element 25. During data writing, an electrical current is supplied to the coil 24, and a magnetic flux 27 is formed via the main magnetic pole 22 and the auxiliary magnetic pole 23. The magnetic flux 27 from the main magnetic pole 22 passes through the recording layer 6 and returns to the auxiliary magnetic pole 23 via the soft under layer 11. Thus, the magnetization direction of each recording bit of the recording layer 6 changes in response to the magnetization flux directed in one of two directions (upward direction or downward direction) perpendicular to the recording layer 6.

In this embodiment, as described above, the seed layer 5a having a (111) surface and being composed of an fcc alloy in which the distance between the centers of the adjacent atoms is about 2.70 Å is formed under the Ru layer 5b. Accordingly, in this embodiment, the Miller index of the surface of the Ru layer 5b can be oriented to (0002) without requiring a Ru layer 5b as thick as that in the related art. Moreover, since the thickness of the Ru layer 5b is decreased, satisfactory writability can be achieved. The thin Ru layer 5b also contributes to reducing the size of the crystal grains constituting the recording layer 6. Furthermore, since the amount of Ru used is decreased, the cost can be reduced.

As described above, according to this embodiment, the Ru layer 5b is highly oriented due to the presence of the seed layer 5a. The recording layer 6 is also highly oriented although the Ru layer 5b is not as thick as that in the related art, and thus high coercive force can thus be achieved. Since the Ru layer 5b need not be thick, satisfactory writability can be achieved. In other words, according to this embodiment, the writability can be improved while maintaining high coercive force. It is also possible to reduce the amount of Ru used.

The thickness of the seed layer 5a is preferably 1 nm to 5 nm, for example. If the thickness of the seed layer 5a is less than 1 nm, then the Ru layer 5b may not be highly oriented. If the thickness of the seed layer 5a is at least 5 nm, the degree of orientation of the Ru layer 5b is sufficient. The thickness of the Ru layer 5b is preferably 5 nm to 20 nm, for example. If the thickness of the Ru layer 5b is less than 5 nm, the noise may not be satisfactorily reduced. If the thickness of the Ru layer 5b exceeds 20 nm, sufficient writability may not be obtained. Alternatively, a Ru—X alloy layer (X=Co, Cr, Fe, Ni, and/or Mn) mainly composed of Ru and having a hexagonal close-packed crystal structure may be disposed instead of the Ru layer 5b.

A tape-shaped film may be used as a substrate of the disk-shaped substrate 1. In such a case, the substrate may be composed of polyester (PE), polyethylene terephthalate (PET), polyethylene naphthalate (PEN), polyimide (PI) having high heat resistant, or any other suitable material.

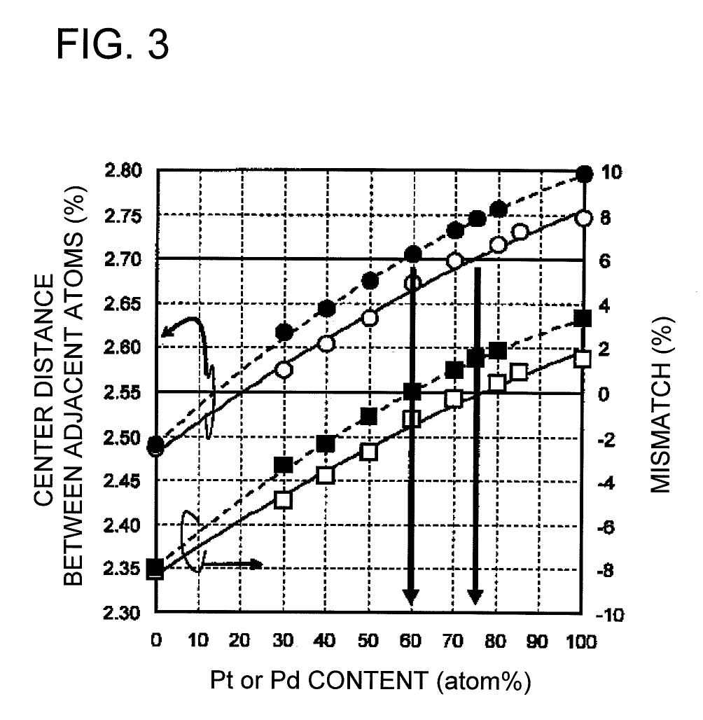

The compositions of Ni—Pt and Ni—Pd, which are examples of the alloys constituting the seed layer 5a, and the distance between the centers of the nearest neighbor atoms will now be described. FIG. 3 is a graph showing the relationship among the center-to-center distance between neighbor atoms, the mismatch (percentage indicating the difference in center-to-center distance) with Ru, and the compositions of Ni—Pt and Ni—Pd. The left vertical axis indicates the distance between the centers of the nearest neighbor atoms in the (111) plane of the Ni—Pt and Ni—Pd, and the right vertical axis indicates the mismatch between the alloys and the (0002) plane of the Ru.

As shown in FIG. 3, for Ni—Pt (the center-to-center distance is indicated by solid circles and the mismatch is indicated by solid squares), the center-to-center distance is about 2.70 Å and the mismatch is about 0% when the Pt content is about 60 atomic percent. For Ni—Pd (the center-to-center distance is indicated by open circles and the mismatch is indicated by open squares), the center-to-center distance is about 2.70 Å and the mismatch is about 0% when the Pd content is about 75 atomic percent. Thus, these percentages are most preferable. The mismatch need not be exactly 0%. The orientation of the (0002) planes of the Ru layer 5b is sufficiently high if the mismatch is 2% or less. For example, in the case where Ni—Pt is used, the Pt content is particularly preferable at about 40 atomic percent to about 70 atomic percent. In the case where Ni—Pd is used, the Pd content is particularly preferable at about 50 atomic percent to 90 atomic percent.

Next, the contents and results of the experiments actually conducted by the present inventors are described.

### First Experiment

In First Experiment, eighteen types of samples were prepared. All samples were prepared by forming an FeCoZrTa layer having a thickness of 25 nm and serving as the amorphous ferromagnetic layer 2 on a glass substrate, forming a Ru layer having a thickness of 0.5 nm and serving as the spacer layer 3 on the FeCoZrTa layer, forming an FeCoZrTa layer having a thickness of 25 nm and serving as the amorphous ferromagnetic layer 4 on the Ru layer, and forming an amorphous Ta layer having a thickness of 3 nm on the FeCoZrTa layer. Then layers (thickness: 5 nm) composed of different materials were formed on the Ta layers, and the Ru layer 5b was formed on each of the Ta layers. The Ru layer 5b was formed by forming two Ru sublayers each having a thickness of 10 nm. A CoCrPt—SiO₂ layer having a thickness of 11 nm and serving as the recording layer 6 was formed on the Ru layer 5b, and a carbon layer serving as the protective layer 7 was formed on the CoCrPt—SiO₂ layer.

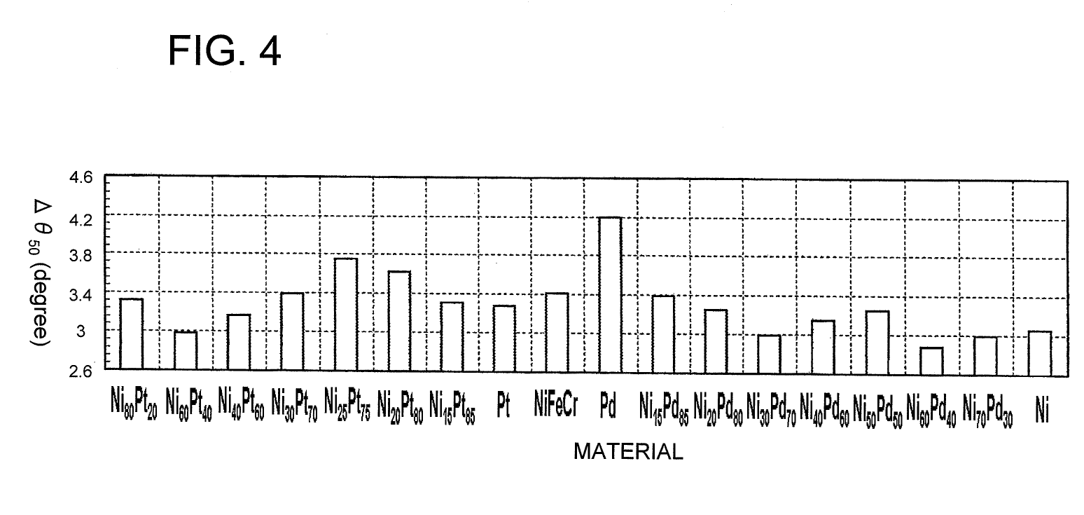

Each sample was analyzed by X-ray diffractometry to determine Δθ₅₀ of the (0002) planes of Ru. The peak (20) of the (0002) planes of Ru was observed at 42.26° when a Cu target was used, and Δθ₅₀ was the half-value width obtained at 2θ=42.260. The results are shown in FIG. 4. The horizontal axis in FIG. 4 indicates the material of the layer formed between the Ta layer and Ru layer 5b in each sample.

As shown in FIG. 4, Δθ₅₀ was particularly low in five samples, namely, Ni₆₀Pt₄₀, Ni₄₀Pt₆₀, Ni₃₀Pd₇₀, Ni₆₀Pd₄₀, and Ni₇₀Pd₃₀. These results indicate that the (0002) faces of Ru were well oriented in these samples.

### Second Experiment

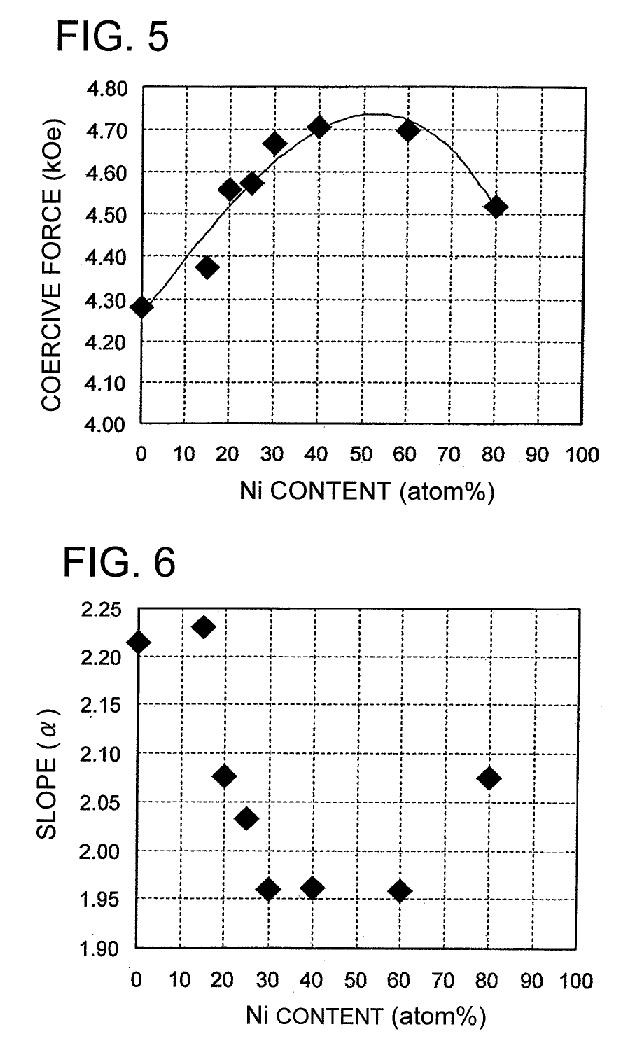

In Second Experiment, the relationship between the composition of Ni—Pt constituting the seed layer 5a and the coercive force of the recording layer 6 was studied. The relationship between the composition of Ni—Pt and the slope a (4 π×dM/dH) for the coercive force of the M-H curve was also studied. The results are shown in FIGS. 5 and 6.

As shown in FIG. 5, a high coercive force was obtained when the Ni content was 20 to 80 atomic percent, and a higher coercive force was obtained when the Ni content was 30 to 60 atomic percent. The optimum coercive force was obtained when the Ni content was 40 to 60 atomic percent. As shown in FIG. 6, the slope α was small when the Ni content was 25 to 60 atomic percent. The optimum value of slope α is obtained when the Ni content was 30 to 60 atomic percent. The value of slope α indicates the extent to which crystal grains of CoCrPt constituting the recording layer 6 are isolated from one another (fineness of the crystal grains). The smaller value of slope α value is preferable since a smaller value indicates a higher degree of granular isolation in the magnetic layer.

### Third Experiment

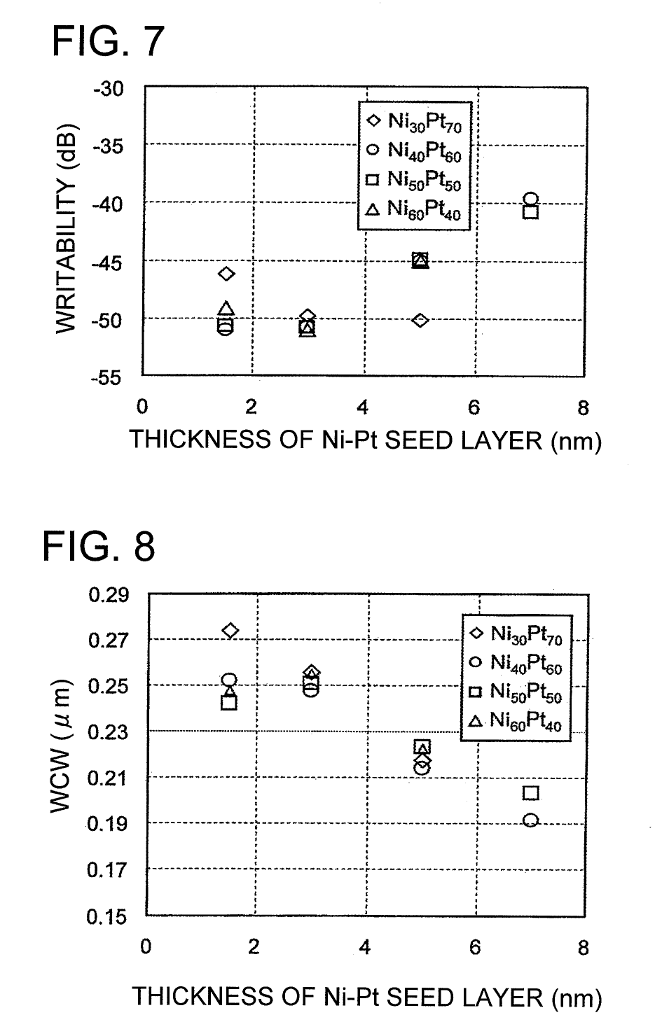

In Third Experiment, the relationship among the composition of Ni—Pt constituting the seed layer 5a, the thickness of the seed layer 5a, and the writability was investigated. The results are shown in FIG. 7. The writability was evaluated on the basis of the ratio between signals that were read when the signals were written at 124 kBPI (kilobytes per inch) and signals that were read when the signals were written at 495 kBPI. The closer the ratio is to −40 dB, the better the writability. All samples were prepared by forming an FeCoZrTa layer having a thickness of 25 nm and serving as the amorphous ferromagnetic layer 2 on a glass substrate, forming a Ru layer having a thickness of 0.5 nm and serving as the spacer layer 3 on the FeCoZrTa layer, forming an FeCoZrTa layer having a thickness of 25 nm and serving as the amorphous ferromagnetic layer 4 on the Ru layer, and forming an amorphous Ta layer having a thickness of 3 nm on the FeCoZrTa layer. Then layers having different thicknesses and composed of different materials were formed on the Ta layers, and the Ru layer 5b having a thickness of 20 nm was formed on each of the Ta layers. A CoCrPt—SiO₂ layer having a thickness of 11 nm and serving as the recording layer 6 was formed on the Ru layer 5b, and a CoCrPtB layer was formed on the CoCrPt—SiO₂ layer. A carbon layer having a thickness of 3 nm and serving as the protective layer 7 was formed on the CoCrPtB layer.

As shown in FIG. 7, the writability improved with the increase in thickness of the seed layer 5a composed of Ni—Pt.

### Fourth Experiment

In Fourth Experiment, the relationship between the composition of Ni—Pt constituting the seed layer 5a, the thickness of the seed layer 5a, and the write core width (WCW) was investigated. The results are shown in FIG. 8. The WCW indicates the width of tracks at which information can be accurately recorded. The smaller the WCW, the higher the track density at which recording is possible.

The results shown in FIG. 8 indicate that the WCW decreases as the thickness of the seed layer 5a composed of Ni—Pt increases.

### Fifth Experiment

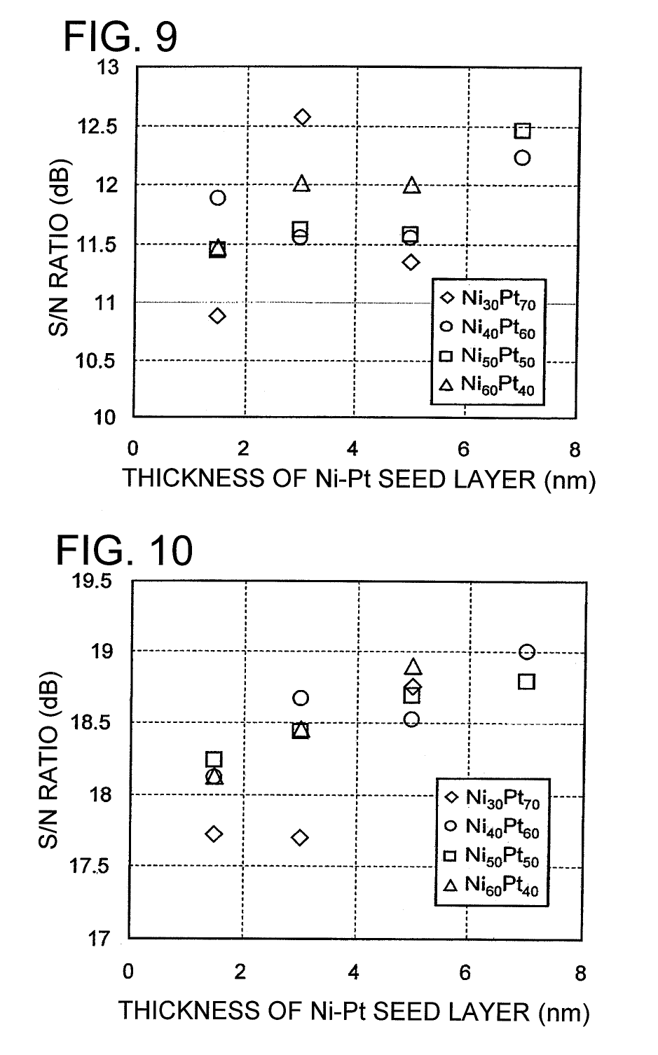

In Fifth Experiment, the relationship between the composition of Ni—Pt constituting the seed layer 5a, the thickness of the seed layer 5a, and the S/N ratio was investigated. The writing density was 124 kBPI and 495 kBPI. The results are shown FIGS. 9 and 10. FIG. 9 shows the results of when the writing density is 495 kBPI, and FIG. 10 shows the results of when the writing density is 124 kBPI.

As shown in FIGS. 9 and 10, the S/N ratio increased with the thickness of the seed layer 5a composed of Ni—Pt.

### Sixth Experiment

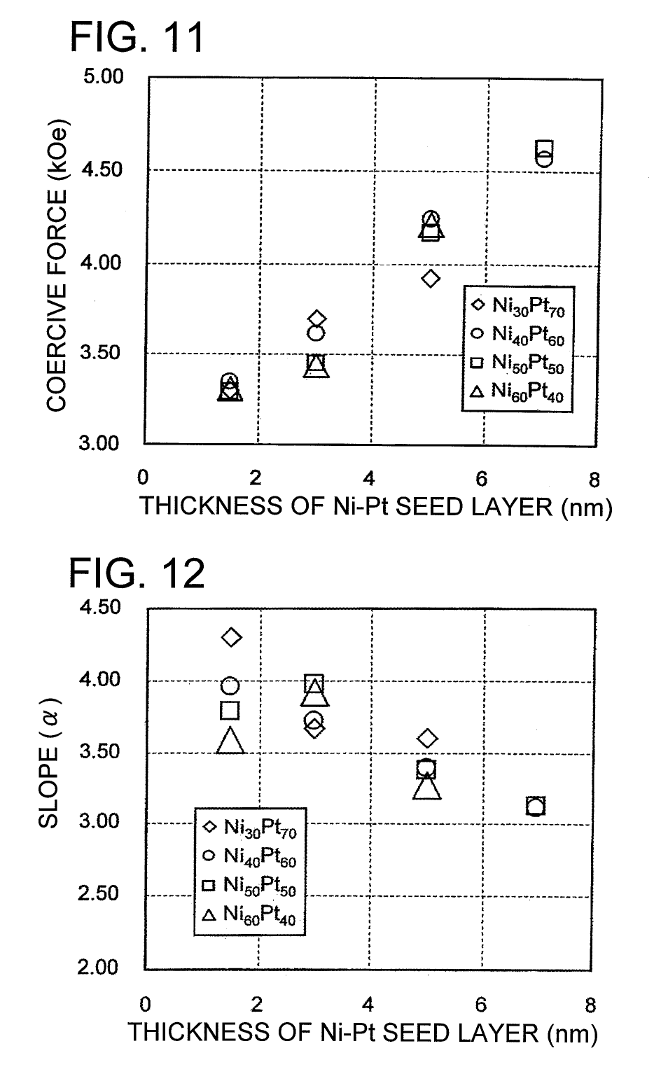

In Sixth Experiment, the relationship between the composition of Ni—Pt constituting the seed layer 5a, the thickness of the seed layer 5a, and the coercive force of the recording layer 6 was investigated. The results are shown in FIG. 11.

As shown in FIG. 11, the coercive force increased with the thickness of the seed layer 5a composed of Ni—Pt.

### Seventh Experiment

In Seventh Experiment, the relationship between the composition of the Ni—Pt constituting the seed layer 5a, the thickness of the seed layer 5a, and the slope α for the coercive force of the M-H curve was investigated. The results are shown in FIG. 12.

As shown in FIG. 12, the slope α decreased as the thickness of the seed layer 5a composed of Ni—Pt increased.

### Eighth Experiment

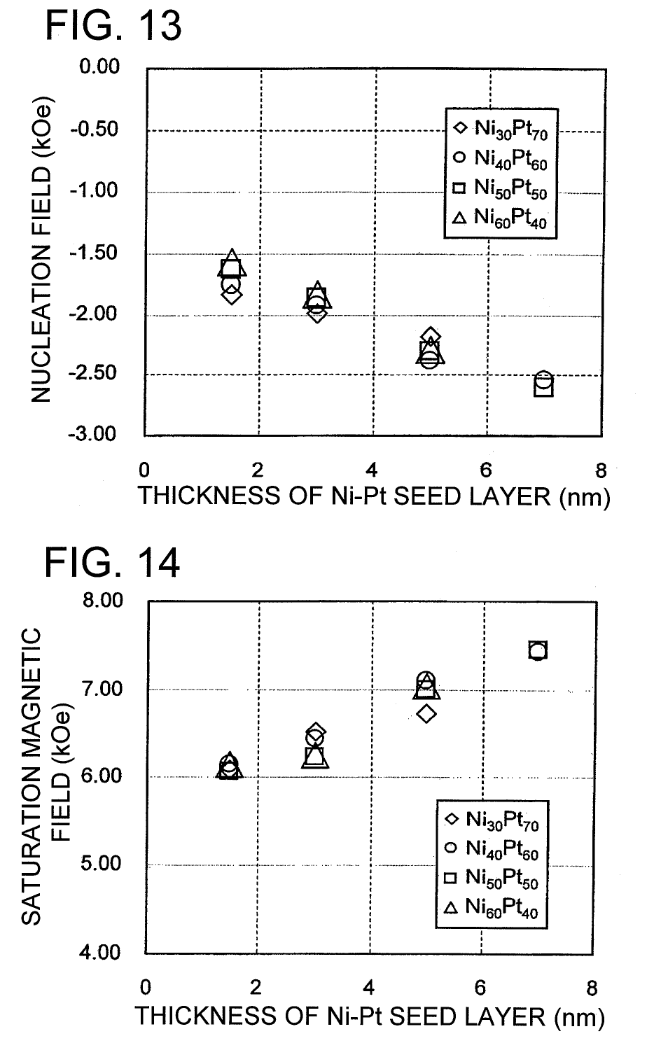

In Eighth Experiment, the relationship between the composition of Ni—Pt constituting the seed layer 5a, the thickness of the seed layer 5a, and the nucleation field required for magnetic reversal was investigated. The results are shown in FIG. 13.

As shown in FIG. 13, the nucleation field decreased as the thickness of the seed layer 5a composed of Ni—Pt increased.

### Ninth Experiment

In Ninth Experiment, the relationship between the composition of Ni—Pt constituting the seed layer 5a, the thickness of the seed layer 5a, and the saturation magnetic field was investigated. The results are shown in FIG. 14.

As shown in FIG. 14, the saturation magnetic field increased with the thickness of the seed layer 5a composed of Ni—Pt.

### Second Embodiment

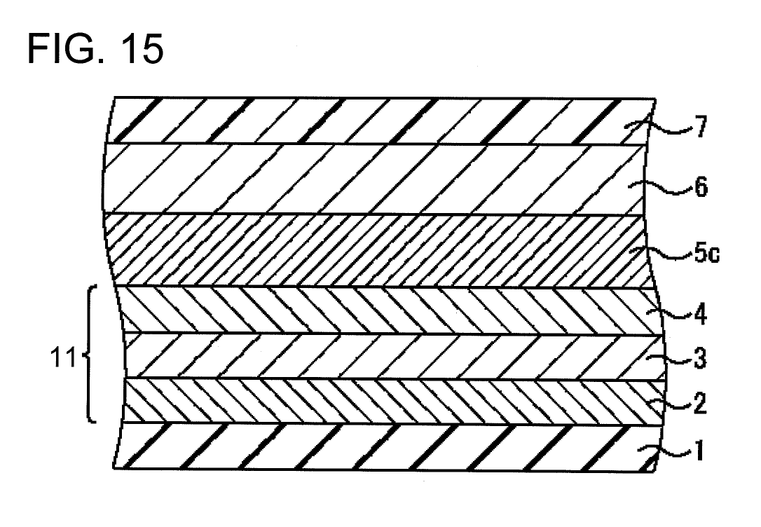

A second embodiment will now be described. FIG. 15 is a cross-sectional view showing the structure of a perpendicular magnetic recording medium according to a second embodiment.

In the second embodiment, as shown in FIG. 15, a seed layer 5c is disposed between the amorphous ferromagnetic layer 4 and the recording layer 6. The seed layer 5c is composed of an alloy having an fcc crystal structure. In this embodiment, the Miller index of the surface of the seed layer 5c is (111). Moreover, the distance between the centers of the adjacent atoms in the seed layer 5c is about 2.67 Å. Examples of such an alloy include Ni—Pt, Ni—Pd, and Cu—Pd. The alloy may further contain SiO₂, TiO₂, Cr, B, Zr, Ta, W, Mn, C and/or Nb, for example. Incorporation of these elements and compounds tends to stabilize the phase, reduce the size of crystal grains, suppress corrosion, and increase the sputtering rate. However, the amount added is preferably less than 20 atomic percent. The seed layer 5c can be made by plating, sputtering, vapor-depositing, CVD, or any other suitable method.

The recording layer 6 has a hexagonal close-packed (hcp) crystal structure, and the length of the “a” parameter is about 2.67 Å. In this embodiment, the Miller index of the surface of the recording layer 6 is (0002). Thus, in this embodiment, the close-packed faces of the crystals constituting the seed layer 5c are parallel to the close-packed faces of the crystals constituting the recording layer 6, and the distance between the centers of the nearest neighbor atoms is substantially the same between the seed layer 5c and the recording layer 6. As in the first embodiment, a ferromagnetic layer mainly composed of Co and Pt is formed as the recording layer 6.

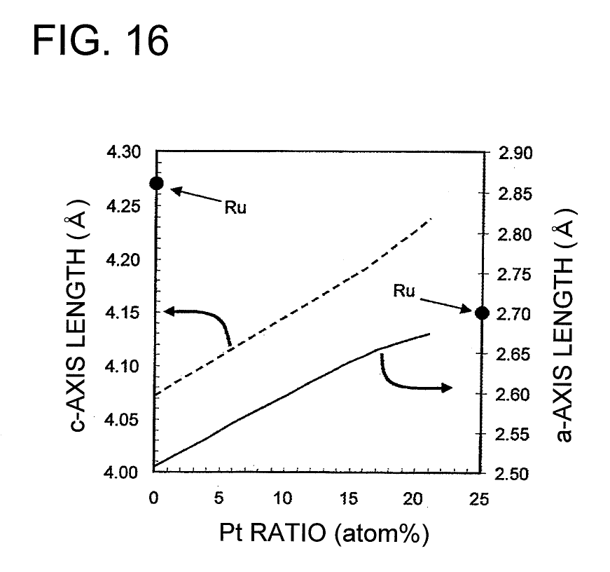

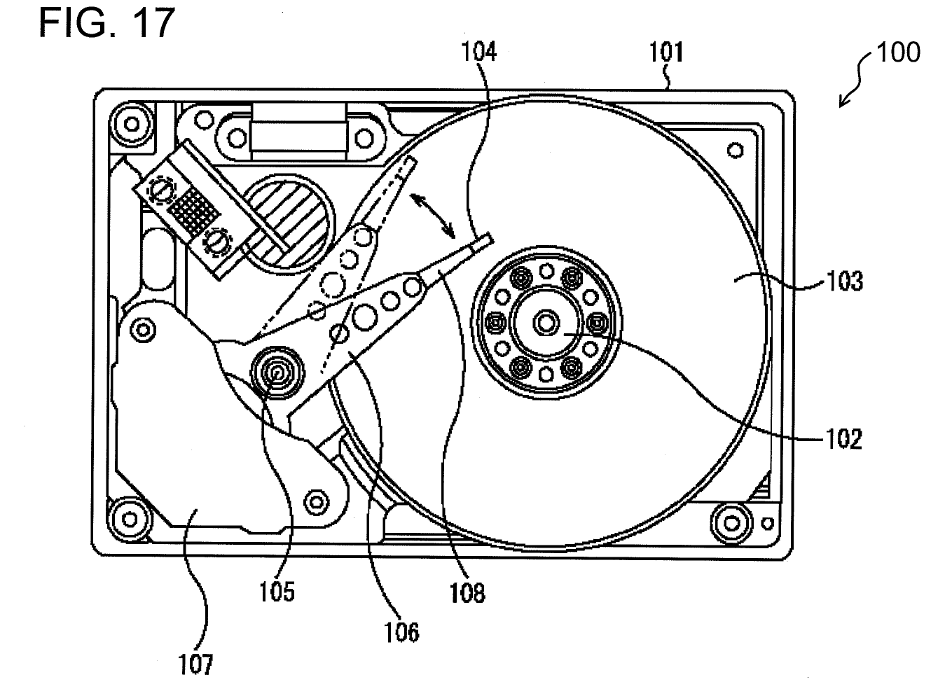

FIG. 16 is a graph showing the relationship between the Pt content in Co—Pt and the lengths of the a-axis and the c-axis. As shown in FIG. 16, the lattice constant of the crystals constituting the recording layer 6 can be controlled by adjusting the composition of the recording layer 6. In this embodiment, the recording layer 6 is mainly composed of Co—Pt having a Pt content of about 21 atomic percent. The seed layer 5c is composed of, for example, Ni₅₀Pt₅₀ or Ni₄₀Pd₆₀. As shown in FIG. 3, the center-to-center distance between the nearest neighbor atoms of Ni₅₀Pt₅₀ is 2.67 Å (indicated by a solid circle) and that of Ni₄₀Pd₆₀ is also about 2.67 Å (indicated by an open circle).

The seed layer 5c magnetically isolates the soft under layer 11 from the recording layer 6. In other words, the seed layer 5c also functions as an intermediate layer. The rest of the structure of the perpendicular magnetic recording medium is the same as that of the first embodiment.

According to the second embodiment, (0002) faces are aligned in the surface of the recording layer 6 without requiring the Ru layer 5b. Moreover, since the Ru layer 5b is omitted, excellent writability is achieved. Accordingly, the second embodiment achieves the same advantages as the first embodiment.

The thickness of the seed layer 5c is preferably about 1 nm to about 20 nm. If the thickness of the seed layer 5c is less than 1 nm, the recording layer 6 may not be satisfactorily oriented and the noise may not be satisfactorily reduced. If the thickness of the seed layer 5c exceeds 20 nm, sufficient writability may not be achieved.

A hard disk drive, which is one example of a magnetic recording apparatus incorporating the perpendicular magnetic recording medium of this embodiment, will now be described. FIG. 17 is a plan view showing the inside structure of a hard disk drive (HDD) 100.

The hard disk drive 100 includes a housing 101. The housing 101 accommodates a rotatable magnetic disk 103 mounted on a rotating shaft 102, a slider 104 that includes a magnetic head that writes information on or reads information from the magnetic disk 103, a suspension 108 that holds the slider 104, a carriage arm 106 that moves along the surface of the magnetic disk 103 about an arm shaft 105 and that has the suspension 108 fixed thereto, and an arm actuator 107 for driving the carriage arm 106. The perpendicular magnetic recording medium described in the aforementioned embodiment is used as the magnetic disk 103.

According to the aforementioned embodiments, a seed layer having an appropriate center-to-center distance between nearest neighbor atoms is interposed between the soft under layer and the recording layer. Thus, the coercive force can be maintained high without having to increase the thickness of the Ru or Ru alloy layer. Thus, writability can be improved while maintaining high coercive force.

What is claimed is:

1. A magnetic recording medium comprising:
a soft under layer,
a seed layer containing an alloy, placed over the soft under layer,
a ruthenium containing layer containing crystalline Ru, directly placed on the seed layer, and
a recording layer placed over the ruthenium containing layer, the alloy containing metal atoms bonded to one another with a minimum distance of adjacent atoms, the crystalline Ru containing metal atoms bonded to one another with a minimum distance, the difference between the minimum distance of the alloy and that of the crystalline Ru being 2% or less.

2. The magnetic recording medium according to claim 1, wherein the recording layer has a cubic close-packed crystal structure and the seed layer has a face-centered cubic crystal structure.

3. The magnetic recording medium according to claim 1, wherein the recording layer has a surface to which (0002) plane of the crystalline Ru is oriented and the seed layer has a surface to which (111) plane of the alloy is oriented.

4. The magnetic recording medium according to claim 1, wherein the seed layer contains at least two elements selected from the group consisting of Ni, Pt, and Pd.

5. The magnetic recording medium according to claim 1, wherein the seed layer contains Ni—Pt or Ni—Pd.

6. The magnetic recording medium according to claim 5, wherein a content of Ni in the seed layer is 20 to 80 atomic percent.

7. The magnetic recording medium according to claim 5, wherein a content of Ni in the seed layer is 30 to 60 atomic percent.

8. The magnetic recording medium according to claim 5, wherein a content of Ni in the seed layer is 40 to 60 atomic percent.

9. The magnetic recording medium according to claim 1, wherein the seed layer contains at least one selected from the group consisting of Cu—Pd, Cu—Pt, Ni—Au, Cu—Au, and Cu—Al.

10. The magnetic recording medium according to claim 9, wherein the seed layer contains at least one selected from the group consisting of SiO₂, TiO₂, Cr, B, Zr, Ta, W, Mn, C and Nb with the content below 20 atomic percent.

11. The magnetic recording medium according to claim 1, wherein the recording layer contains Co and Pt.

12. The method according to claim 11, wherein the recording layer further contains at least one selected from the group consisting of Cr, B, SiO₂, TiO₂, CrO₂, CrO, Cu, Ti, CoO, Mn, W, and Nb.

13. A method for making a magnetic recording medium comprising the steps of:
forming a soft under layer,
forming a seed layer containing an alloy over the soft under layer,
forming a ruthenium containing layer containing crystalline Ru directly on the seed layer, and
forming a recording layer over the ruthenium containing layer, the alloy containing metal atoms bonded to one another with a minimum distance of adjacent atoms, the difference between the minimum distance of the alloy and that of the crystalline Ru being 2% or less.

14. The method according to claim 13, wherein the recording layer has a cubic close-packed crystal structure, and the seed layer has a face-centered cubic crystal structure.

15. The method according to claim 13, the recording layer has a surface to which (0002) plane of the crystalline Ru is oriented and the seed layer has a surface to which (111) plane of the alloy is oriented.

16. The method according to claim 13, wherein the seed layer contains at least two elements selected from the group consisting of Ni, Pt, and Pd.

17. The method according to claim 13, wherein the seed layer contains Ni—Pt or Ni—Pd.

18. The method according to claim 13, wherein the recording layer contains Co and Pt.

19. A magnetic recording apparatus comprising:
a magnetic recording medium including:
a soft under layer,
a seed layer containing an alloy, placed over the soft under layer,
a ruthenium containing layer containing crystalline Ru, directly placed on the seed layer, and
a recording layer placed over the ruthenium containing layer, the alloy containing metal atoms bonded to one another with a minimum distance of adjacent atoms, the crystalline Ru containing metal atoms bonded to one another with a minimum distance, the difference between the minimum distance of the alloy and that of the crystalline Ru being 2% or less; and
a magnetic head facing the magnetic recording medium for reading and writing information from and on the magnetic recording medium.
